(19) United States
(12) Patent Application Publication
(10) Pub. No.: US 2011/0053789 A1
(43) Pub. Date: Mar. 3, 2011

(54) MIRCOARRAY METHODS

(75) Inventor: Malcolm James Simons, Bell Post Hill (AU)

(73) Assignee: SIMONS HAPLOMICS LIMITED

(21) Appl. No.: 12/161,166

(22) PCT Filed: Dec. 29, 2006
(86) PCT No.: PCT/AU06/01977

§ 371 Date: Aug. 6, 2010

(30) Foreign Application Priority Data
Jan. 5, 2006 (AU) 2006900060

(51) Int. Cl. C40B 30/04; C40B 40/06; C40B 30/00

(52) U.S. Cl. 506/9; 506/16; 506/7

(57) ABSTRACT

The present invention provides a method for identifying a microarray probe set capable of identifying a member of a group of related nucleotide sequences, the method comprising the steps of providing a candidate probe set comprising at least one probe capable of differentially hybridizing to two or more members of the group of related nucleotide sequences, testing reactivity of the probe set against two or more members of the group of related nucleotide sequences, and observing the degree of difference in the patterns of reactivity of the probe set for the two or more members of the group of related nucleotide sequences.

### FIELD OF THE INVENTION

The present invention relates to methods for the detection of specific nucleic acid sequences from test samples containing large numbers of such sequences, such as those derived from the full genetic complement of mRNAs or genes in a prokaryotic or eukaryotic cell. Particularly, the present invention relates to methods for selecting probes for use in microarray applications.

### BACKGROUND TO THE INVENTION

Microarray technology has revolutionized the field of genetics by providing the means for screening a test mixture containing nucleic acid molecules using large numbers of unique probes. Microarray analysis is considered in the art as a classic ‘precision in-precision out’ technology. Experiments based on sound experimental design, optimized protocols, properly designed array elements, well designed probe sets, pure samples, robust manufacturing and surface chemistry, high-quality scanning, and correctly applied sample tracking, quantification and data mining tools are capable of yielding valuable results.

Probe design for microarray applications has been subject to a great deal of research. Although technology is improving and growing more robust, difficulties remain in selecting unique and informative probes for each target nucleotide sequence that is to be detected in the sample. One reason is that no matter how carefully a probe set is selected, at least a proportion of the probes will bind with more than one target sequence due to the well known phenomenon of cross-hybridization. Other factors such as the formation of secondary structure and the melting temperature of probes may also cause hybridization error, which in turn reduces experimental accuracy.

The prior art provides a number of theoretical models (often embodied in software-based algorithms) for selection of informative probes that are less likely to elicit hybridization error in a microarray environment. Research at Affymetrix Inc led to the first probe-designing program to generate short probes of 20 to 25 bases for use on a microarray platform (Chee et al, Science (1996) Oct. 25; 274 (5287):610-4). The research identified a number of criteria for selecting robust and informative probes, namely:
1. homogeneity, to ensure that the probes can bind to target molecules at the temperature of the experiment,
2. sensitivity, to ensure that the probes will not form a secondary structure. (such a structure will prevent the probes from binding to the targeted cDNAs.), and
3. specificity, to ensure that the probes remain unique even after several bases are changed.

It is acknowledged in the art that algorithms based on these principles can greatly reduce the time and effort spent on laboratory testing each target molecule for probe reactivity. However, it is also accepted that there are limitations to this approach, one of the main problems being that because all probes reside on a single microarray chip, only a single set of hybridization conditions can be used for any given probe set. This limitation increases the likelihood of cross-hybridization and hybridization errors because conditions (such as ionic strength and temperature) cannot be optimized for each probe individually. Clearly, further improvements are needed in the area of probe selection for microarray platforms.

It is an aspect of the present invention to provide methods for identifying probes for use in microarrays that overcome or alleviate a problem of the prior art.

The discussion of documents, acts, materials, devices, articles and the like is included in this specification solely for the purpose of providing a context for the present invention. It is not suggested or represented that any or all of these matters formed part of the prior art base or were common general knowledge in the field relevant to the present invention as it existed before the priority date of each claim of this application.

### SUMMARY OF THE INVENTION

In one aspect the present invention provides a method for identifying a microarray probe set capable of identifying a member of a group of related nucleotide sequences, the method comprising the steps of providing a candidate probe set comprising at least one probe capable of differentially hybridizing to two or more members of the group of related nucleotide sequences, testing reactivity of the probe set against two or more members of the group of related nucleotide sequences, and observing the degree of difference in the patterns of reactivity of the probe set for the two or more members of the group of related nucleotide sequences. In contrast to the prior art methods, the methods of the present invention do not require the deliberate and systematic design of a probe set based on a detailed knowledge of target sequences. Instead, the present methods rely on the proposition that observed, empiric reactivity patterns of probes can provide sufficient discriminating power to allow for a determination of the presence or absence of a predetermined nucleotide sequence in a sample. Preferably the degree of difference in patterns of reactivity is sufficient such that substantially all members of the group of related nucleotide sequences display a unique pattern of reactivity, the candidate probe set is an informative probe set.

In one form of the invention a genetic feature (e.g. the presence of a mutation), or a genetically-linked feature (e.g. a phenotype) is known about the members of the group of related nucleotide sequences or the organisms from which the members are obtain or derived from such that the unique pattern of reactivity is informative of the presence or absence of the genetic feature or the genetically-linked feature.

In a preferred form of the invention the candidate probe set is produced by the method comprising dividing the nucleotide sequence of each member of the group of related nucleotide sequences into a plurality of subsequences, wherein at least two of the subsequences overlap and wherein the candidate probe set is directed to the subsequences.

In another aspect the present invention provides an informative probe set or a partially informative probe set produced by the methods described herein. Typically, the probes will be oligonucleotide probes of about 25 nucleotides in length. The probes may be bound to a solid matrix for use in a microarray format

Throughout the description and claims of this specification, the word “comprise” and variations of the word, such as “comprising” and “comprises”, are not intended to exclude other additives or components or integers.

### BRIEF DESCRIPTION OF THE FIGURES

FIG. 1 shows the hypothetical application of a preferred method of selecting a probe set. In this case, there are three related 19-mer sequences (#1, #2 and #3). Taking the first nucleotide in the exon as 1 (i.e. the 5^{th} nucleotide in), the exon has two SNPs at positions 6 and 11 (underlined). The related sequences are divided into 9-mer subsequences, with complete overlap between the subsequences. FIG. 1B shows all subsequences pooled from related sequences #1, #2 and #3.

### DETAILED DESCRIPTION OF THE INVENTION

The applicant proposes an alternative method for designing a microarray probe set capable of identifying a genetic feature of an organism (such as a single nucleotide polymorphism; SNP) or a genetically-linked feature of an organism (such as a phenotype). The method is a significant departure from in silico and in vitro methods practiced by skilled artisans in designing probes suitable for screening samples by microarray. The prior art methods involve a detailed consideration of the differences in nucleotide sequences that are found in, for example, alleles of a gene. Once the differences are identified, probes are then designed such that they specifically hybridize to certain target nucleotide sequences within in the gene. The pattern of hybridization with the probes is then informative of the allele. This approach can be problematic since the hybridization of oligonucleotide probes with a target sequence is not ideal such that simple Watson-Crick bases pairing is the only consideration required. Thus, the nucleotide sequence of the probe does not necessarily determine the ability of a probe to bind to a target nucleotide sequence. The basis of this non-ideal behavior is not completely understood, however it is thought that the presence of secondary structure in the probe and/or target sequence is involved.

In contrast to the prior art methods, the methods of the present invention do not require the deliberate and systematic design of a probe set based on a detailed knowledge of target sequences. Instead, the present methods rely on the proposition that observed, empiric reactivity patterns of probes can provide sufficient discriminating power to allow for a determination of the presence or absence of a predetermined nucleotide sequence in a sample. Accordingly, the present invention provides a method for identifying a microarray probe set capable of identifying a member of a group of related nucleotide sequences, the method comprising the steps of providing a candidate probe set comprising at least one probe capable of differentially hybridizing to two or more members of the group of related nucleotide sequences, testing reactivity of the probe set against two or more members of the group of related nucleotide sequences, and observing the degree of difference in the patterns of reactivity of the probe set for the two or more members of the group of related nucleotide sequences.

The group of related nucleotide sequences may be obtained from a cell, a cell of a unicellular organism or a cell of a multicellular organism. For example, each member of the group of related nucleotide sequences may be obtained from a different organism, each organism displaying a different phenotype. The member sequence may not necessarily be directly obtained from an organism. It is possible that the member sequence is derived from the organism, for example by synthesizing in vitro a replicate member sequence.

The degree of difference may be such that some, most or all members of the group of related nucleotide sequences display a unique pattern of reactivity. Depending on the application of the method, it may not be necessary that all members display a unique pattern of reactivity, however in a preferred form of the invention the degree of difference in patterns of reactivity is sufficient such that substantially all members of the group of related nucleotide sequences display a unique pattern of reactivity. In this situation the candidate probe set is considered an informative probe set because definitive information on an unknown test sample can be provided by utilizing the same probe set, and noting the pattern of probe reactivity. It is emphasized that that the probe set does not necessarily need to be fully informative (i.e. be capable of resolving all member sequences), and partially informative probe sets (i.e. capable of resolving only a proportion of all member sequences) are included in the scope of the invention.

In one embodiment of the method a genetic feature, or a genetically-linked feature is known about the member sequences, or the organisms from which the member sequences are obtained or derived from, such that the unique pattern of reactivity is informative of the presence or absence of the genetic feature or the genetically-linked feature. Thus, the pattern of reactivity noted for any given sample may be related back to a known genetic characteristic or a genetically-linked characteristic of the organism from which the member of the group of related nucleotide sequences is obtained from or derived from. As a non-limiting example, it may be desired to identify whether an individual has one or more mutations in the gene responsible for cystic fibrosis (the CFTR gene). This gene has some 1,200 mutations (including SNPs and in-frame deletions) of which only around 200 polymorphisms are not known to be associated with genic dysfunction. The art currently consider it virtually impossible to identify probes having an achievably narrow window of hybridization conditions for optimal +/− interpretation of each individual probe. This mindset arises from the parsimonious assumption that each single SNP-hybridising probe must be informative in isolation. Using the methods of the present invention, a candidate probe set is selected, and reactivity is tested against DNA from individuals having all of the 1,200 possible mutations, including individuals having all of the 200 polymorphisms not thought to be involved in the cystic fibrosis phenotype. The probe set and conditions are chosen such that the pattern of reactivity for the normal individual is distinct from the patterns of reactivity seen for the person having a dysfunctional CFTR gene. In the prior art, this process would have been performed by designing a probe set, each probe being designed individually to identify each of the 1,200 mutations. While this may well be possible given that the mutations are well characterized, this approach has not been successful to date. Without wishing to be limited by theory, it is thought that this failure is due to the fact that no matter how carefully the probes are selected using theoretical considerations, a proportion of the probes will not behave as expected by virtue of the inherent inability to customize hybridization conditions for each probe individually.

The current view of microarray use is that it is considered that the role of each single probe is to provide unitary information, and that can only be done under a specific hybridization protocol that is common to all the probes. Yet it is understood that it is impossible to predict the behavior of a single probe under a particular hybridization protocol. The applicant proposes for the first time that it is immaterial whether any one probe performs according to theoretical expectation. Furthermore it is proposed that it is irrelevant that the hybridization conditions employed are not optimal for any one of the multiple probes used on the microarray. Indeed, the present invention may be operable where the hybridization conditions are not optimal for even a single probe in the probe set.

The method requires the step of providing a candidate probe set. As used herein, the term “candidate probe set” is intended to include a set of probes that the skilled person would predict may provide a sufficient degree of difference in the patterns of reactivity between the members of the group of related nucleotide sequences. The skilled person could not predict with any certainty whether any given candidate probe set will provide the requisite difference in reactivity patterns. Accordingly, the present methods include the possibility that a number of candidate probe sets may need to be trialed before an acceptable group of probes is identified. As will be appreciated, the methods described herein owe more to an empiric approach to probe selection, as distinct from the methods of the prior art that rely on hybridization theory. However, it will be desirable for the number of trials to be minimized, and so various exemplary strategies are proposed herein to achieve this aim. It should be understood that the inventive methods are not restricted to any of the strategies described herein. Indeed, in one form of the invention, there is no consideration of the target sequence and a random or semi-random set of probes could be used as the candidate probe set. By trialing a random or semi-random probe set it could be shown empirically that reactivity pattern “A” is noted only in persons having allele “X” of a gene, and reactivity pattern “B” is seen only in persons having allele “Y”. Thus, by identifying the sequences of the differentially reactive probes retrospectively, it will be possible to recreate the informative probe set.

In another form of the invention, the candidate probe set relies in part on knowledge of the nucleotide sequences of the target molecules. In this case, probes may be directed to a plurality of overlapping subsequences in the target molecules. While this approach requires knowledge of the target sequences, it avoids the necessity of deliberately designing probes to cover all expected nucleotide sequences. This approach generates a large number of probes however takes advantage of the ability of a microarray chip to accommodate very large numbers of probes.

In one form of the invention a set of candidate probes is identified by dividing the target sequence under consideration into overlapping subsequences. To increase the potential for reactivity difference, each member of the group of related sequences is divided into a number of subsequences. Within a given member sequence, the subsequences overlap each other such that a potentially large number of subsequences may be generated.

Preferably, at least one of the subsequences overlaps with more than one other subsequence. More preferably, at least one of the subsequences overlaps with more than 2, 3, 4 or 5 other subsequences.

The degree of overlap used to generate the series of overlapping probe-length subsequences may be the minimum possible. An example of minimum overlap for a series of 25-mer subsequences would be where the first subsequence covers nucleotides 1 to 25, the second subsequence covers nucleotides 25 to 50, the third subsequence covers nucleotides 50 to 75, et cetera.

The overlap may be the maximum degree of overlap possible. An example for a series of 25-mer subsequences having the maximum possible overlap would be where the first subsequence covers nucleotides 1 to 25, the second subsequence covers nucleotides 2 to 26, the third subsequence covers nucleotides 3 to 27, et cetera.

The invention includes any intermediate degree of overlap between the minimum and maximum available. However, the use of substantially maximum overlap is preferred since this requires the least amount of judgement on the part of the individual designing the probe set.

It is not necessary for the amount of overlap to be fixed for the use of the method with any given member of the group. It is also not necessary for the length of the subsequence to be fixed. It will be possible for the skilled person to routinely investigate the effects of varying subsequence lengths and degree of overlap between the subsequences to ascertain whether any advantage is gained in respect of reactivity difference.

It is emphasized that the inventive methods are not limited to candidate probe sets including probes directed to overlapping subsequences of the target nucleotide sequences. Use of any candidate probe set that allows for at least a minimum degree of differential probe reactivity is included in the scope of the invention

The related nucleic acid sequences can be genomic, RNA, cDNA, or cRNA. Genomic DNA samples are usually subject to amplification before application to an array using primers flanking the region of interest. Genomic DNA can be obtained from virtually any tissue source (other than pure red blood cells). For example, convenient tissue samples include—whole blood, semen, saliva, tears, urine, fecal material, sweat, buccal, skin and hair. Amplification of genomic DNA containing a polymorphic site generates a single species of target nucleic acid if the individual from the sample was obtained is homozygous at the polymorphic site or two species of target molecules if the individual is heterozygous.

The DNA may be prepared for analysis by any suitable method known to the skilled artisan, including by PCR using appropriate primers. Where it is desired to analyze the entire genome, the method of whole genome amplification (WGA) may be used. Commercial kits are readily available for this method including the GenoPlex® Complete WGA kit manufactured by Sigma-Aldrich Corp (St Louis, Mo., USA). This kit is based upon random fragmentation of the genome into a series templates. The resulting shorter DNA strands generate a library of DNA fragments with defined 3 primed and 5 primed termini. The library is replicated using a linear, isothermal amplification in the initial stages, followed by a limited round of geometric (PCR) amplifications. Another commercially available kit is REPLI-g, manufactured by Qiagen GmbH (Hilden, Germany). WGA methods are suitable for use with purified genomic DNA from a variety of sources including blood cards, whole blood, buccal swabs, soil, plant, and formalin-fixed paraffin-embedded tissues.

mRNA samples are also often subject to amplification. In this case amplification is typically preceded by reverse transcription. Amplification of all expressed mRNA can be performed as described in WO 96/14839 and WO 97/01603. Amplification of an RNA sample from a diploid sample can generate two species of target molecule if the individual from whom the sample was obtained is heterozygous at a polymorphic site occurring within expressed mRNA.

As will be apparent, the nucleotide subsequences identified by the method may be subsequently used to design a probe set capable of identifying all currently identified members of the group of related sequences. As used herein the term “target nucleotide sequence” means a sequence against which a substantially specific probe may be generated. The generation of probes is discussed further infra, however the probe is typically an oligonucleotide probe capable of hybridizing to the target nucleotide sequence.

The skilled person will understand that the length of the probe-length subsequences may be any length that provides the ability to discriminate between the members of the group of related sequences. Probes used for microarray applications are typically about 25 nucleotides in length, however longer and shorter probes are contemplated to be useful in the context of the invention. A lower useful length may be determined by the need for sufficient nucleotides to provide specificity of binding, and may be from about 10 nucleotides to about 15 nucleotides. Probes of less than 15 nucleotides could be contemplated where a “sub-genome” is under test. An example of this is where single haploid chromosomes are under test, and sequence detection specificity does not require a probe length needed to analyze the approximately 3 billion nucleotides in the entire genome of a human. The upper limit may be determined by physical constraints relating to the need to melt double-stranded regions and anneal single strands of polynucleotide. This may be from about 30 to about 50 nucleotides. The upper limit may vary according to the proportion of C/G bases given the higher melting temperatures needed to separate these bases in a duplex, as compared with an A/T pairing. While there may be practical upper and lower limits for the length of probe, these limits will vary according to the specifics of the application and the skilled person will be able to identify the probe of most appropriate length by routine empirical experimentation.

It is anticipated that while it may be necessary to trial a number of candidate probe sets, it may also be necessary to trial a number of hybridization conditions to ensure that all members of the group of related nucleotide sequences are faithfully detected. For example, hybridization conditions may be optimized once the final probe set is selected to provide a better signal-to-noise ratio for certain marginal probes. Conditions may also be optimized in cases where a candidate probe set fails to adequately detect all members of a group of related nucleotide sequences. Altering hybridization conditions may result in the ability of the probe set to identify all members of the group.

Initial hybridization conditions could initially be of low stringency, including low temperature, low ionic strength and low detergent concentrations. A typical buffer for low stringency hybridization includes 1×SSC and 0.2% SDS. A typical temperature for low stringency is about 42 degrees Celsius.

If low stringency conditions do not provide a requisite degree of difference in probe reactivity then a higher stringency buffer containing 0.1×SSC and 0.2% SDS may be used. A temperature of about 65 degrees Celsius may also be trialed. Denaturing agents such as formamide can also be introduced into buffers to alter the level of stringency, with higher concentrations lowering the melting points of the nucleic acid molecules.

By routine experimentation the skilled person will be able to identify a particular probe set for use in conjunction with particular hybridization conditions such that the requisite degree of difference in probe reactivity patterns is achieved.

It will be understood that the method may be applied to any situation where it is necessary to discriminate between a number of related nucleotide sequences. As used herein, the term “nucleotide sequence” and variations thereof is intended to include deoxyribonucleic acid (DNA) and ribonucleic acid (RNA) sequences. The related nucleotide sequences may be any group of nucleotide sequences that exhibit a minimum level of sequence identity. Preferably the sequences have an identity of at least 50%, 60%, 70%, 80%, 90%, 95% or 99%. The identity may be even higher than 99% where, for example, the related sequences are long, and there are a series of SNPs scattered throughout.

The related sequences may be protein coding, non-protein coding, or a combination of protein coding and non-protein coding. The related sequences may be derived from diploid, haploid, triploid or polyploid material, or provide information on the diploid, haploid, triploid or polyploid state. The related sequences may be natural or synthetic. They may be from any organism including an animal, plant, microorganism, bacterium, or virus.

In one form of the invention, the related sequences are directed to the same region of the genome. For example, the region from the first nucleotide of an exon to the last nucleotide of the exon. In this case, and where a 25-mer probe is to be used, the probe may be designed such that the 13^{th} nucleotide of the probe (i.e. the central nucleotide) is directed to the first nucleotide of the exon. Thus, where the first nucleotide is G, the 13^{th} nucleotide of the probe will be C. It will be apparent that the flanking 12-mer regions of the probe will be directed in one case to the pre-exon region and in the other case, further into the exon.

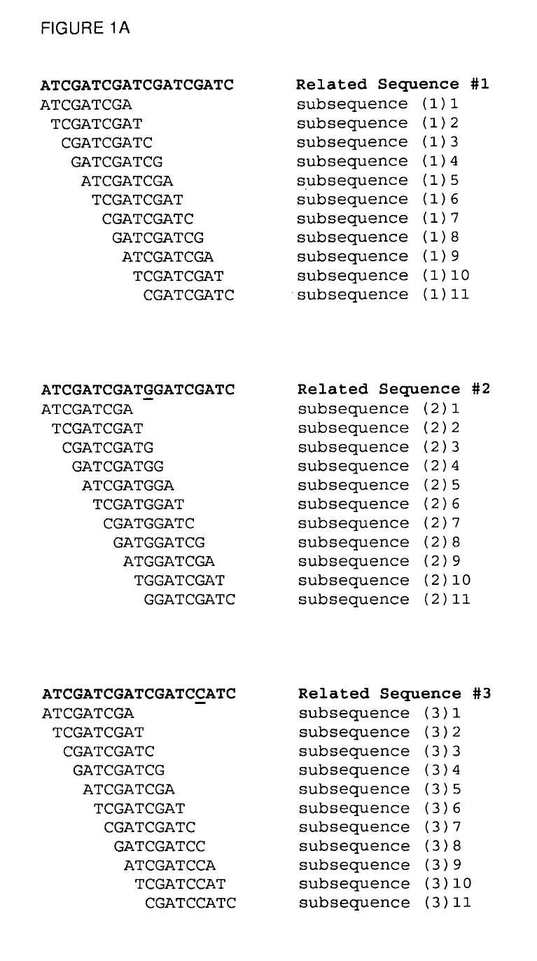

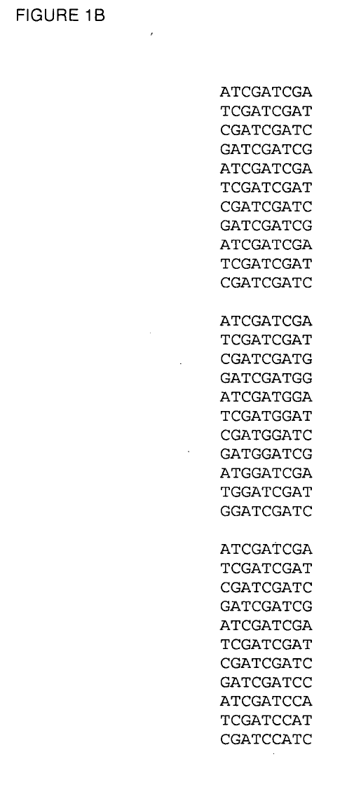

The general operation of an overlapping strategy used in a preferred embodiment of the invention of the method can be demonstrated by consideration of the greatly simplified example shown in FIG. 1. This demonstration is directed to 3 related nucleotide sequences (#1, #2 and #3), with the exon starting at the 5^{th} nucleotide in from the left hand or 5′ end (i.e. A). Taking the first nucleotide in the exon as 1, the exon has two SNPs at positions 6 and 11 (underlined). Subsequences of 9 nucleotides were used, with there being complete overlap in the subsequences. Thus, the first subsequence commences at position −4 and terminates at position +5.

As will be apparent from FIG. 1A, each related sequence is divided into 11, 9-mer subsequences. This provides a total of 33 subsequences (FIG. 1B). The skilled person will understand that the probe sequences do not need to be complimentary if the original target molecule was a double-stranded (ds) molecule. In that case, the nucleotide sequence can be directly used as the probe sequence or complimented to ACAGGGGTGTCGTGCAAAGAACCTC, depending on the target generation strategy chosen by the skilled artisan. Thus, the probe can be directed to either strand, or both, on the array if dsDNA is used in final target generation.

The methods of the present invention will allow analysis of many variations in nucleotide sequences including deletions, substitutions, additions and the like. In one form of the invention the related nucleotide sequences are identical except for the presence of SNPs.

While the SNPs may be present at any density, the methods provide greater advantages where the SNPs are present at a high density. Preferably the density is such that two or more SNPs are present within a probe length region of the nucleotide sequence. The ability to distinguish related nucleotide sequences that include SNPs at high density has previously been problematic since it has hitherto been thought necessary to provide a large number of probes to cover every combination of SNPs in a given region. This has especially been an issue in designing probe sets for HLA typing where 20% to 50% of the nucleotides in HLA exons are polymorphic, and often the polymorphic sites are clustered. This has resulted in the prior art predicting that a practically infeasible number of different probes would be required to definitively ascribe an HLA type to an individual.

It will be clear that while the number of related nucleotide sequences in the group may be as low as two, the method provides an increased advantage where the number of related nucleotide sequences is high. In a preferred form of the method the number of related nucleotide sequences in the group of related nucleotide sequences is more than 100, 200, 300, 400, 500, 600, 700, 800, 900 or 1000. The present invention is particularly applicable where the number of related nucleotide sequences is high and the density of SNPs is high.

In a preferred form of the method, the related nucleotide sequences are alleles of a gene. It is known that a human gene encoding the same protein may have different sequences (alleles) in different individuals. Examples of genes having high numbers of alleles are mainly those involved in the immune system, where hypervariability is a common feature. Exemplary genes include those of the major histocompatibility complex (MHC), the T-cell receptor, the B-cell receptor, immunoglobulins, the killer inhibitory receptor (KIR), and the like. It will be understood however, that the methods described herein will be useful for any group of related nucleotide sequences, but that a greater advantage is gained where the related nucleotide sequences are hypervariable. A greater advantage still is provided where the hypervariability exits as high density SNPs.

As mentioned supra, MHC genes are extremely polymorphic. Class I and II MHC transmembrane proteins make up the Human Leukocyte Antigen (HLA) system that is used in tissue typing for the purposes of assessing transplant compatibility. Class I proteins are encoded by three loci: HLA-A, HLA-B and HLA-C that currently recognize 309, 563 and 167 alleles respectively.

Class II proteins have an alpha and beta chain, and are encoded by the loci DR, DQ and DP. The DR loci comprise 3 alleles for alpha and 483 for the beta chain. The DQ loci comprise 25 alleles for alpha and 56 for beta. The DP loci comprise 20 alleles for alpha and 107 for beta. It will therefore be noted that for the Class I region alone, there are many combinations of alleles that provide the HLA type of an individual.

In one form of the method, the method is amenable to automation. Methods of the prior art such as Guo et al (2002) design probes based on the careful consideration of all related nucleotide sequences in an effort to identify probes that cover all observed combinations of SNPs. This is of course very labour intensive, and the success or failure dependant on the expertise of the individual performing the analysis. The task of designing probes may become practically infeasible if the number of related sequences is very large, or the number of alleles is very large.

The method may include a combination of different subsequence lengths and different levels of overlap between the subsequences. In a highly preferred form of the invention the subsequence is about 25 nucleotides in length, and the degree of overlap is maximal.

It will be appreciated that the presence of a hitherto unrecognised allele may also be discovered by the present invention. An individual showing a new pattern of reactivity could be found. It will be possible to identify the probe(s) where the new reactivity shows up, and deduce the new allele.

As discussed supra, the allele analysed may be directed to protein-coding regions exclusively, or noncoding regions exclusively. Alternatively, a combination of noncoding and protein-coding regions may be used.

Given the target subsequences, the skilled person will be capable of synthesizing probes capable of hybridising with each target subsequence. The probes are substantially complimentary to the non-redundant sequences identified. The probes may be sense or antisense if the target is generated from a double stranded template.

It is well within the ability of the skilled person to investigate whether any advantage is gained by the use of modified nucleotides in probes designed by the instant methods, such as locked nucleic acids.

The probe may include a label to facilitate detection. Exemplary labels include Cy5, Cy3, FITC, rhodamine, biotin, DIG and various radioisotopes.

In another aspect the present invention provides a microarray method of identifying a member of a group of related nucleotide sequences using a set of probes as described herein. Accordingly, another aspect the invention provides a set of probes as described herein immobilized on a solid matrix. An exemplary embodiment of this form of the invention is found in the GeneChip® technology marketed by Affymetrix®. This technology relies on a photolithographic process by coating a 5″×5″ quartz wafer with a light-sensitive chemical compound that prevents coupling between the wafer and the first nucleotide of the DNA probe being created. Lithographic masks are used to either block or transmit light onto specific locations of the wafer surface. The surface is then flooded with a solution containing either adenine, thymine, cytosine, or guanine, and coupling occurs only in those regions on the glass that have been deprotected through illumination. The coupled nucleotide also bears a light-sensitive protecting group, so the cycle can be repeated. Other methods of immobilizing probes are provided by a number of companies including Oxford Gene Technology (Oxford, U.K.), Agilent Technologies (Palo Alto, Calif., U.S.A.) and Nimblegen Systems Inc (Madison, Wis., U.S.A).

It will be appreciated that the present invention will have application in a wide range of technical fields. It is anticipated that the field of medicine will gain particular advantage, where the method may be used for genotyping individuals. The methods will be particularly useful in transplantation tissue typing (e.g. using the HLA genes, KIR genes, minor histocompatibility loci, and the like), as well as pharmacogenomics, DNA “fingerprinting” and the like. The probes may be used for any application comprising in situ hybridization, slot blot, dot blot, colony hybridization, plaque hybridization, Northern blotting, Southern blotting, as well as microarray applications,

It is anticipated that applications will extend to use in non-human animals such as primates, for example in the pre-clinical pharmacogenomic assessments of candidate pharmaceuticals. The invention is also contemplated to be useful for testing of animals having economic importance (such as cattle, poultry and the like), for example in breeding programs to improve parameters such as lean muscle content.

1. A method for identifying a microarray probe set capable of identifying a member of a group of related nucleotide sequences, the method comprising the steps of providing a candidate probe set comprising at least one probe capable of differentially hybridizing to two or more members of the group of related nucleotide sequences, testing reactivity of the probe set against two or more members of the group of related nucleotide sequences, and observing the degree of difference in the patterns of reactivity of the probe set for the two or more members of the group of related nucleotide sequences.

2. A method according to claim 1 wherein where the degree of difference in patterns of reactivity is sufficient such that substantially all members of the group of related nucleotide sequences display a unique pattern of reactivity, the candidate probe set is an informative probe set.

3. A method according to claim 1 or claim 2 wherein each member of the group of related nucleotide sequences is obtained or derived from two or more organisms.

4. A method according to any one of claims 1 to 3 wherein a genetic feature, or a genetically-linked feature is known about the members of the group of related nucleotide sequences or the organisms from which the members are obtain or derived from such that the unique pattern of reactivity is informative of the presence or absence of the genetic feature or the genetically-linked feature.

5. A method according to any one of claims 1 to 4 wherein the candidate probe set is produced by the method comprising dividing the nucleotide sequence of each member of the group of related nucleotide sequences into a plurality of subsequences, wherein at least two of the subsequences overlap and wherein the candidate probe set is directed to the subsequences.

6. A method according to claim 5 wherein at least three of the subsequences overlap with each other.

7. A method according to claim 5 wherein at least four of the subsequences overlap with each other.

8. A method according to claim 1 wherein at least five of the subsequences overlap with each other.

9. A method according to claim 5 wherein the overlap is complete overlap.

10. A method according to any one of claims 1 to 9 wherein the related sequences differ by the presence of one or more nucleotide polymorphisms.

11. A method according to claim 10 wherein the nucleotide polymorphisms are single nucleotide polymorphisms.

12. A method according to any one of claims 1 to 11 wherein the subsequences are probe-length.

13. A method according to any one of claims 1 to 12 wherein the subsequences are from about 10 to about 50 nucleotides in length.

14. A method according to any one of claims 1 to 12 wherein the subsequences are from about 15 to about 35 nucleotides in length.

15. A method according to any one of claims 1 to 12 wherein the subsequences are about 25 nucleotides in length.

16. A method according to any one of claims 1 to 15 wherein all subsequences are of the same or similar length.

17. A method according to any one of claims 1 to 16 wherein the related nucleotide sequences have a sequence identity of at least 50%, 60%, 70%, 80%, 90%, 95% or 99%.

18. A method according to any one of claims 1 to 17 wherein the related sequences exhibit SNPs at a high density.

19. A method according to any one of claims 1 to 18 wherein the related sequences are protein coding, non-coding, or a combination of protein coding and non-coding.

20. A method according to any one of claims 1 to 19 wherein the related sequences are directed to the same region of a genome.

21. A method according to any one of claims 1 to 20 wherein the related nucleotide sequences are alleles of a gene.

22. A method according to any one of claims 1 to 21 wherein the number of related nucleotide sequences in the group of related nucleotide sequences is more than 100, 200, 300, 400, 500, 600, 700, 800, 900 or 1000.

23. A method according to any one of claims 1 to 22 wherein the related nucleotide sequences are part of a gene locus involved in the immune system.

24. A method according to claim 23 wherein the locus is a locus of the Major Histocompatibility Complex (MHC), the T-cell receptor, the B-cell receptor, the Killer Inhibitory Receptor, or an immunoglobulin.

25. A method according to claim 23 wherein the locus is a locus of the Human Leukocyte Antigen (HLA) system.

26. A method according to any one of claims 1 to 25 wherein the method is amenable to automation.

27. An informative probe set or a partially informative probe set produced by the method according to any one of claims 1 to 26.

28. A probe set according to claim 27 wherein at least one probe comprises a label selected from the group consisting of Cy5, Cy3, FITC, rhodamine, biotin, DIG and a radioisotope.

29. A solid matrix comprising an immobilized probe set according to claim 27 or claim 28.

30. A solid matrix according to claim 29 wherein the solid matrix is a microarray chip.

31. A microarray method of identifying a member of a group of related nucleotide sequences using a probe set according to claim 27 or claim 28.

32. A method of identifying a genetic feature or a genetically-linked feature of an organism, the method comprising the use of a probe set according to claim 27 or claim 28.

33. A method of definitive allele assignment comprising use of a probe set according to claim 27 or claim 28.

34. A method of transplantation tissue typing based on the HLA system comprising use of a probe set according to claim 27 or claim 28.

35. A method of identifying a new allele comprising use of a probe set according to claim 27 or claim 28.

36. A method according to claim 5 substantially as hereinbefore described with reference to the Figures.
